(19) United States
(12) Patent Application Publication
(10) Pub. No.: US 2021/0112191 A1
(43) Pub. Date: Apr. 15, 2021

(54) IMAGING CONTROL DEVICE, IMAGING CONTROL METHOD, AND NON-TRANSITORY COMPUTER-READABLE RECORDING MEDIUM

(71) Applicant: Panasonic Intellectual Property Management Co., Ltd., Osaka (JP)

(72) Inventors: Kazuki MAENO, Kanagawa (JP); Yasunobu OGURA, Kanagawa (JP); Tomoyuki KAGAYA, Kanagawa (JP)

(21) Appl. No.: 17/108,294

(22) Filed: Dec. 1, 2020

Related U.S. Application Data
(63) Continuation of application No. PCT/JP2019/018270, filed on May 7, 2019.

(30) Foreign Application Priority Data
Jun. 11, 2018 (JP) 2018-111389

(51) Int. Cl. H04N 5/232; G06K 9/00; G06T 7/00

(52) U.S. Cl. CPC H04N 5/23216; H04N 5/23219; G06K 9/00288; G06T 2207/30201; G06K 9/00255; G06T 2207/30168; G06T 7/0002

(57) ABSTRACT

An imaging control device determining a group of parameters related to a shooting operation of a camera, comprising a communication circuit inputting imaging data generated by the camera and a control circuit selecting a group of parameters set in the camera from candidate groups of parameters based on the imaging data, wherein the control circuit acquires, via the communication circuit, each imaging data generated by the camera to which each candidate group of parameters is set, extracts a plurality of face images each including a human face, from the imaging data for each candidate group, calculates an evaluation value on image quality corresponding to a degree of match of automatic face recognition based on the plurality of face images for each candidate group, and selects any one group of parameters from the candidate group of parameters based on evaluation values on image quality.

### CROSS-REFERENCE TO RELATED APPLICATIONS

This is a continuation application of International Application No. PCT/JP2019/018270, with an international filing date of May 7, 2019, which claims priority of Japanese Patent Application No. 2018-111389 filed on Jun. 11, 2018, each of the content of which is incorporated herein by reference in its entirety.

### TECHNICAL FIELD

The present disclosure relates to an imaging control device, an imaging control method, and a computer program for determining a parameter related to a shooting operation of a camera.

### BACKGROUND ART

Japanese Patent No. 5829679 discloses an imaging device using a contrast method for focusing. This imaging device uses different search conditions suitable for respective searches between when a combination of a subject image area and a partial image area of the same person is searched for and when it is determined again after detection of a combination of a subject image area and a partial image area whether the detected area includes an image searched for. While suppressing a detection failure of a person by searching for a combination of the subject image area and the partial image area, an area erroneously detected at the time of searching for the combination is excluded by re-determination so as to improve a detection rate of a person or a face. The improvement in the detection rate leads to stabilization of a focus searching area. This improves the stability of focus control when the contrast method is used for focusing.

Japanese Patent No. 4921204 discloses an imaging device imaging a monitored object. This imaging device has an automatic exposure control means changing values of operation parameters including an aperture value and at least one of a shutter speed and a gain value and thereby bring a luminance level of an output signal of an imaging element closer to a desired value. If the brightness of the monitored object decreases while the aperture value is set to a predetermined value near a small aperture end, the automatic exposure control means preferentially changes the aperture value when an abnormality monitoring mode is set as compared to when a normal monitoring mode is set. As a result, an abnormal state is photographed with high image quality and the durability is improved.

### SUMMARY

The present disclosure provides an imaging control device, an imaging control method, and a computer program for determining a parameter corresponding to an installation status of a camera, stored on a non-transitory computer-readable recording medium.

The imaging control device of the present disclosure is an imaging control device determining a group of parameters related to a shooting operation of a camera, including: a communication circuit inputting imaging data generated by the camera; and a control circuit selecting a group of parameters set in the camera from candidate groups of parameters based on the imaging data, and the control circuit acquires, via the communication circuit, each imaging data generated by the camera to which each candidate group of parameters is set, extracts a plurality of extraction object images each including an extraction object, from the imaging data for each candidate group, calculates an evaluation value on image quality based on the plurality of extraction object images for each candidate group, and selects anyone group of parameters from the candidate groups of parameters based on evaluation values on image quality.

These general and specific aspects may be implemented by a system, a method, and a computer program, as well as a combination thereof.

According to the imaging control device, the imaging control method, and the computer program of the present disclosure, a group of parameters to be set in the camera is determined based on evaluation values on image quality calculated based on the imaging data of the camera. Therefore, the parameters corresponding to the installation status of the camera can be determined.

### BRIEF DESCRIPTION OF DRAWINGS

FIG. 1 is a block diagram showing a configuration of an imaging control device according to first and second embodiments.

FIG. 2 is a flowchart showing determination of parameters in the first embodiment.

FIG. 3 is a flow chart showing calculation of an image quality evaluation value.

FIG. 4 is a diagram for explaining a feature vector.

FIG. 5 is a flowchart showing determination of parameters in the second embodiment.

FIG. 6 is a flow chart showing generation of parameter vectors by genetic algorithm.

FIG. 7 is a flowchart showing generation of parameter vectors of the next generation.

FIG. 8 is a flowchart for explaining crossover.

FIG. 9 is a flowchart for explaining mutation.

FIG. 10 is a flowchart for explaining copying.

### DETAILED DESCRIPTION

### Knowledge Underlying the Present Disclosure

When a camera such as a surveillance camera is newly installed or an installation position is changed due to layout change, a group of parameters related to a shooting operation of the camera may be set to appropriate values corresponding to the installation status of the camera. For example, the installation status of the camera includes an installation position of the camera and the lighting condition of the surrounding environment.

The group of parameters related to the shooting operation of the camera includes multiple types of parameters for setting an exposure time, focus, compression quality, etc. However, it is difficult for humans to determine the optimum values of multiple types of parameters in consideration of the installation position of the camera, the lighting condition of the surrounding environment, etc. For example, if the exposure time is made longer to reduce noise in an image, blurring easily occurs due to a motion. If the aperture is opened large to reduce noise in an image, the depth of field becomes shallow and blurring easily occurs due to a distance. A trade-off relationship also exists between camera brightness and a tendency to blur. Therefore, it is difficult for humans to determine which parameter should be set to which value.

Furthermore, hundreds of surveillance cameras may be installed in facilities such as an airport or a shopping center or in a city. It takes time to manually determine the group of parameters for each of such a large number of surveillance cameras according to the installation position of the camera, the lighting condition of the surrounding environment, etc. Moreover, when the positions of the cameras once installed are changed due to a layout change, it is not easy to manually reset the group of parameters if the number of cameras is large.

The present disclosure provides (I) an imaging control device determining multiple types of parameters related to a shooting operation of a camera to appropriate values corresponding to the installation position of the camera, the lighting condition of the surrounding environment, etc.

Multiple surveillance cameras may be used to search for a particular person. Automatic face recognition using machine learning such as deep learning is recently performed in such surveillance cameras etc. It is difficult to determine optimal parameter values for the automatic face recognition based on human subjective evaluation. For example, a person determines that image quality is good if characteristics in a high frequency region remain. However, in the automatic face recognition, a frequency region at a certain level or higher is not used because of sensitivity to noise. Furthermore, whether a parameter is good or bad depends on an automatic face recognition algorithm used. However, it is difficult for humans to determine which of a blurred bright image and a sharp dark image is suitable for automatic face recognition.

In Japanese Patent No. 5829679, focus control is performed based on contrast of a region desired to be focused on in a captured image. However, if the shutter speed is increased to improve the contrast, the luminance level decreases. On the other hand, if the shutter speed is reduced to improve the luminance level, the contrast decreases due to a motion blur. Therefore, when only the contrast is used as an index, the luminance level is not taken into consideration, and face recognition may adversely be affected. Therefore, the contrast is not necessarily an index suitable for face recognition.

In Japanese Patent No. 4921204, brightness adjustment of a captured image is implemented by a method of bringing a luminance level closer to a desired value. However, the luminance level is not necessarily an appropriate index for face recognition. Additionally, how the desired value is set is not clearly defined. Therefore, the desired value suitable for face recognition is not set.

Therefore, it is conventionally difficult to determine multiple types of parameters related to a shooting operation of a camera to values suitable for face recognition.

The present disclosure provides (II) an imaging control device determining a group of parameters suitable for face recognition.

Embodiments will be described in terms of an imaging control device determining parameters having (I) appropriate values corresponding to an installation position of a camera, the lighting condition of the surrounding environment, etc. and (II) the values suitable for face recognition. Specifically, the imaging control device of the present disclosure calculates an evaluation value on image quality based on a feature amount of a face image from a moving image captured by a camera such as a surveillance camera and determines a group of parameters set in the camera based on the evaluation value on image quality. As a result, a group of parameters corresponding to the installation position of the camera, the lighting condition of the surrounding environment, etc. and suitable for face recognition can be set in the camera. Therefore, the performance of face recognition is improved.

### First Embodiment

A first embodiment will now be described with reference to the drawings. In this embodiment, setting of a group of parameters of a camera suitable for face recognition using deep learning will be described.

1. Configuration

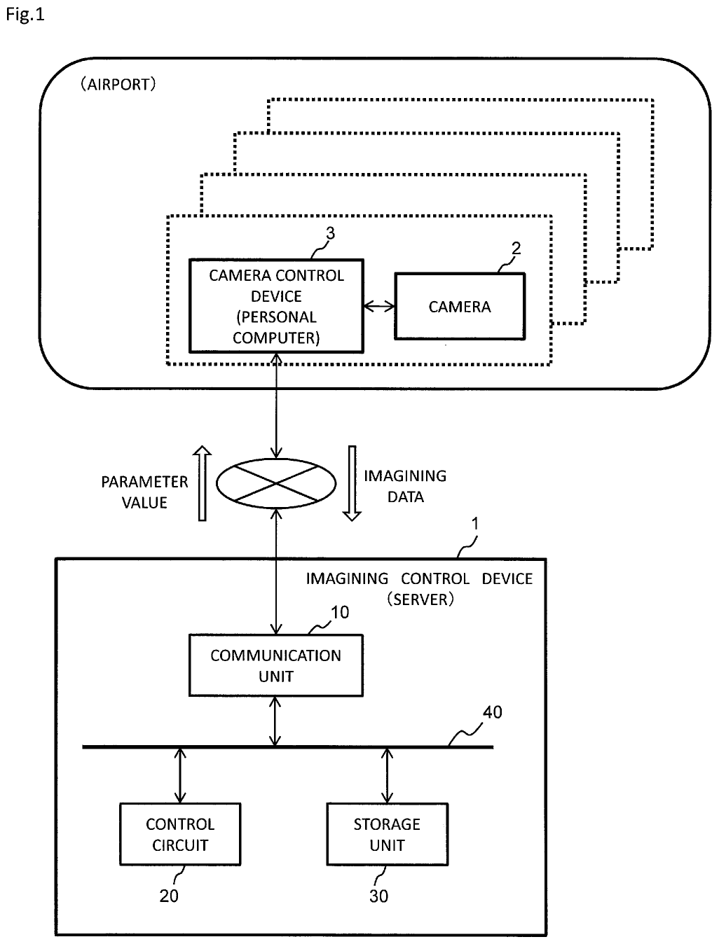

FIG. 1 shows an electrical configuration of an imaging control device according to the present disclosure. For example, an imaging control device 1 is a server, a camera 2 is a surveillance camera, and a camera control device 3 is a personal computer. The imaging control device 1 is, for example, a cloud server, and is connected to one or more camera control devices 3 via the Internet. In the example of FIG. 1, one camera 2 is connected to one camera control device 3. The imaging control device 1 determines respective groups of parameters of the multiple cameras 2 when the multiple cameras 2 are newly installed in an airport etc., for example.

The imaging control device 1 includes a communication unit 10, a control circuit 20, a storage unit 30, and a bus 40.

The communication unit 10 includes a communication circuit communicating with an external device in conformity with a predetermined communication standard. Examples of the predetermined communication standard includes LAN, Wi-Fi (registered trademark), Bluetooth (registered trademark), USB, and HDMI (registered trademark).

The control circuit 20 controls the operation of the imaging control device 1. The control circuit 20 can be implemented by a semiconductor element etc. The control circuit 20 is a control circuit such as a microcomputer, a CPU, an MPU, a GPU, a DSP, an FPGA, or an ASIC, for example. The function of the control circuit 20 may be constituted only by hardware or may be implemented by combining hardware and software. The control circuit 20 implements a predetermined function by reading data and a computer program stored in the storage unit 30 and performing various arithmetic processes. The computer program executed by the control circuit 20 may be provided from the communication unit 10 etc. or may be stored in a portable recording medium.

The control circuit 20 determines a groups of parameters related to the shooting operation of the camera 2 based on imaging data generated by the camera 2. The group of parameters of the camera 2 includes multiple types of parameters affecting image quality. For example, the group of parameters includes one or more of aperture value, gain, white balance, shutter speed, and focal length.

The storage unit 30 can be implemented by, for example, a hard disk (HDD), an SSD, a RAM, a DRAM, a ferroelectric memory, a flash memory, a magnetic disk, or a combination thereof.

The bus 40 is a signal line electrically connecting the communication unit 10, the control circuit 20, and the storage unit 30.

The imaging control device 1 may further include a user interface allowing a user to input various operations. For example, the imaging control device 1 may include a keyboard, buttons, switches, and a combination thereof.

The camera 2 includes an image sensor such as a CCD image sensor, a CMOS image sensor, or an NMOS image sensor.

The camera control device 3 sets the camera 2 based on the group of parameters determined by the imaging control device 1.

2. Operation

### 2.1 Determination of Parameter Vectors

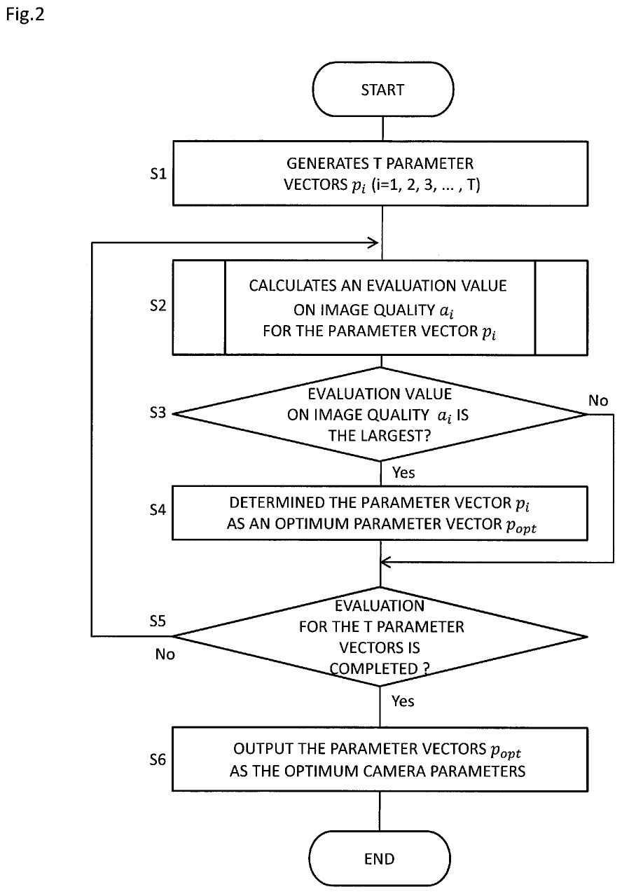

FIG. 2 is a flowchart showing an operation of determining parameter vectors by the control circuit 20 of the imaging control device 1.

The control circuit 20 generates T parameter vectors pᵢ (i=1, 2, . . . , T), i.e., parameter vectors p₁, p₂, p₃, . . . , P_{T} (S1). The parameter vectors pi is a group of parameters including multiple parameters. For example, each of the parameter vectors pᵢ includes M elements, which are parameters p_{i,1}, p_{i,2}, p_{i,3} . . . P_{i,M}. The parameters p_{i,1}, p_{i,2}, p_{i,3} . . . P_{i,M} correspond to aperture value, gain, white balance, shutter speed, focal length, etc. The T parameter vectors pᵢ form T patterns of the parameter vectors pᵢ. Specifically, one or more of the elements included in the parameter vector pᵢ have different values from the elements of the same type included in the other parameter vectors pᵢ. For example, at least one of aperture value, gain, white balance, shutter speed, and focal length is different. Any method is used for generating the T parameter vectors pᵢ. For example, T parameter vectors pᵢ may be generated by combining all settable values. The T parameter vectors pᵢ generated at step S1 is a candidate group of parameters which will be finally set in the camera 2.

The control circuit 20 calculates an evaluation value on image quality aᵢ for the parameter vector pᵢ (S2). The evaluation value on image quality aᵢ in this embodiment is related to image recognition and specifically corresponds to a degree of match for face recognition.

The control circuit 20 determines whether the calculated evaluation value on image quality aᵢ is the largest of the already calculated image quality evaluation values (S3). If the evaluation value on image quality aᵢ is the largest, the parameter vector pᵢ is determined as an optimum parameter vector pₒₚₜ (S4). If the image quality evaluation value aᵢ is not the largest, step S4 is skipped.

The control circuit 20 determines whether the evaluation based on the evaluation value on image quality aᵢ is completed for all the T parameter vectors pᵢ (S5). If any of the parameter vectors pᵢ is not evaluated, the process returns to step S2.

When the evaluation is completed for the T parameter vectors pᵢ, the parameter vectors pₒₚₜ is output to the camera control device 3 as the optimum camera parameters (S6).

### 2.2 Calculation of Evaluation Value on Image Quality

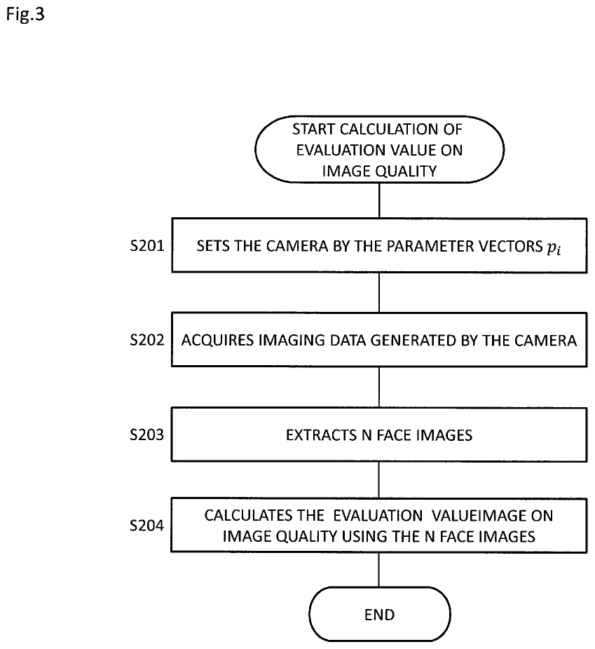

FIG. 3 shows details of the calculation (S2) of the evaluation value on image quality. The control circuit 20 sets various parameters of the camera 2 by outputting the parameter vectors pᵢ to the camera control device 3 (S201).

The control circuit 20 acquires imaging data generated through shooting by the camera 2 set to the value indicated by the parameter vector pᵢ (S202). The imaging data is, for example, a moving image including one or more images. The control circuit 20 extracts N face images from the imaging data (S203). Any method is used for extracting the face image.

The control circuit 20 calculates the evaluation value on image quality aᵢ using the N face images (S204). For example, the evaluation value on image quality aᵢ is calculated based on features of N face images. The control circuit 20 records the parameter vector pᵢ and the evaluation value on image quality aᵢ correlated with each other in the storage unit 30.

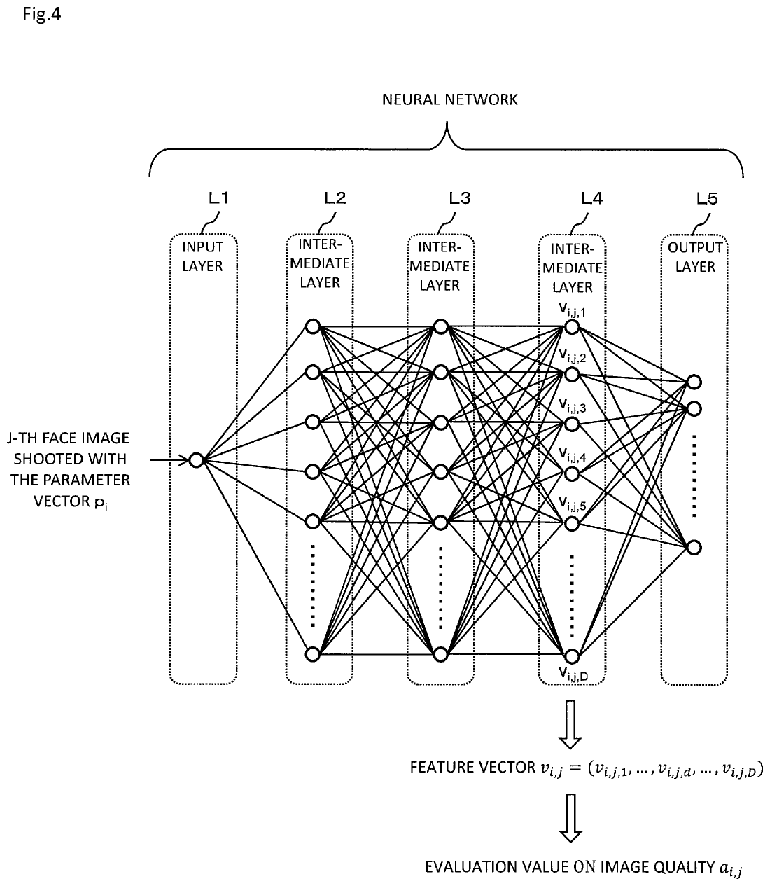

A specific example of calculation of the evaluation value on image quality aᵢ (S204) will be described with reference to FIG. 4. FIG. 4 shows an example of calculation of a feature vector v_{i,j}, which is an example of the feature of the face image. In this embodiment, the feature vector v_{i,j} (j=1, 2 . . . , N) is generated using a neural network having learned a face image. For example, the neural network associates learning data indicative of a large number of face images with labels indicative of who the face images are for the learning in advance. The learned neural network is stored in the storage unit 30. The neural network has a multi-layer structure used for deep learning. For example, the neural network includes an input layer L1, intermediate layers L2, L3, L4, and an output layer L5. The number of the intermediate layers is not limited to three. The intermediate layer includes one or more layers. The neural network outputs, for example, a vector indicative of who the face image input to the input layer L1 is from the output layer L5.

The control circuit 20 sequentially inputs first to N-th face images extracted at step S203 to the input layer L1 of the neural network. In this embodiment, for example, for a j-th (j=1, N) face image, the feature vectors v_{i,j}=(v_{i,j,1}, v_{i,j,2}, v_{i,j,3}, . . . , v_{i,j,D}) are generated from node values v_{i,j,1}, v_{i,j,2}, V_{i,j,3}, . . . , v_{i,j,D} of the intermediate layer L4 closest to the output layer L5.

The control circuit 20 calculates the evaluation value on image quality a_{i,j} for each face image from the respective feature vectors v_{i,j} (j=1, N) of N face images. Specifically, the control circuit 20 calculates an L2 norm value l_{i,j} of the feature vector v_{i,j} for each of the N evaluation values on image quality a_{i,j} by Eq. (1). A relationship exists between the L2 norm and image quality (see, e.g., Raj eev Ranjan, Carlos D. Castillo, Rama Chellappa, “L2-constrained Softmax Loss for Discriminative Face Verification”). Therefore, in this embodiment, the value l_{i,j} of the L2 norm is used as the evaluation value on image quality a_{i,j} for each of the face images.

$$\begin{matrix}[ Math . 1 ] & \\ {a}_{i , j} = {l}_{i , j} = \sqrt{{\sum }_{d = 1}^{D} {v}_{i , j , d}^{2}} & ( 1 )\end{matrix}$$

The control circuit 20 calculates an average value of the evaluation values on image quality a_{i,j} of the N face images as the evaluation value on image quality aᵢ of the parameter vector pᵢ as shown in Eq. (2).

$$\begin{matrix}[ Math . 2 ] & \\ {a}_{i} = \frac{1}{N} {\sum }_{j = 1}^{N} {a}_{i , j} & ( 2 )\end{matrix}$$

### 3. Effects and Supplements

The imaging control device 1 determines a group of parameters related to the shooting operation of the camera 2. The imaging control device 1 includes the communication unit 10 inputting imaging data generated by the camera 2, and the control circuit 20 selecting a group of parameters to be set in the camera from multiple candidate groups of parameters based on the imaging data. The control circuit 20 acquires via the input unit the imaging data generated by the camera to which each candidate group of parameters is set, extracts multiple face images from the imaging data for each of the candidate groups, calculates an evaluation value on image quality based on multiple face images for each of the candidate groups, and selects one of the groups of parameters from multiple candidate groups of parameters based on the evaluation values on image quality.

In this way, by determining the group of parameters based on the imaged data of the camera 2, parameter values corresponding to the installation position of the camera 2 and the lighting condition of the surrounding environment can be selected. Therefore, for example, when hundreds of surveillance cameras may be installed in a facility such as an airport or a shopping center, this eliminates the need for a person to determine the parameter values of each camera in accordance with the installation position of the camera 2 and the lighting condition of the surrounding environment, so that a work cost due to parameter adjustment can be reduced.

Furthermore, according to this embodiment, the group of parameters to be set in the camera 2 is determined based on the evaluation value on image quality indicative of a degree of match for face recognition calculated from the imaging data of the camera 2. Therefore, the performance of face recognition is improved.

The control circuit 20 selects the group of parameters providing the largest evaluation value on image quality among the evaluation values on image quality of the respective candidate groups of parameters. As a result, the optimum group of parameters may be selected in accordance with the installation position of the camera 2 and the lighting condition of the surrounding environment. Additionally, the optimum group of parameters for face recognition may be selected. For example, when a face is erroneously detected, the evaluation value on image quality becomes low. This can prevent selection of a group of parameters causing an erroneous face detection.

The control circuit 20 calculates the evaluation value on image quality by calculating the L2 norm of the features of the multiple face images. A relationship exists between the L2 norm of the features of the face images and the image quality. Therefore, by selecting a group of parameters based on the evaluation value on image quality calculated from the L2 norm of the features of the face images, a group of parameters corresponding to the installation position of the camera 2 and the lighting condition of the surrounding environment and suitable for face recognition is selected.

### Second Embodiment

In the first embodiment, any method is used for generating T parameter vectors (S1). In this embodiment, a genetic algorithm (GA) is used to generate T parameter vectors.

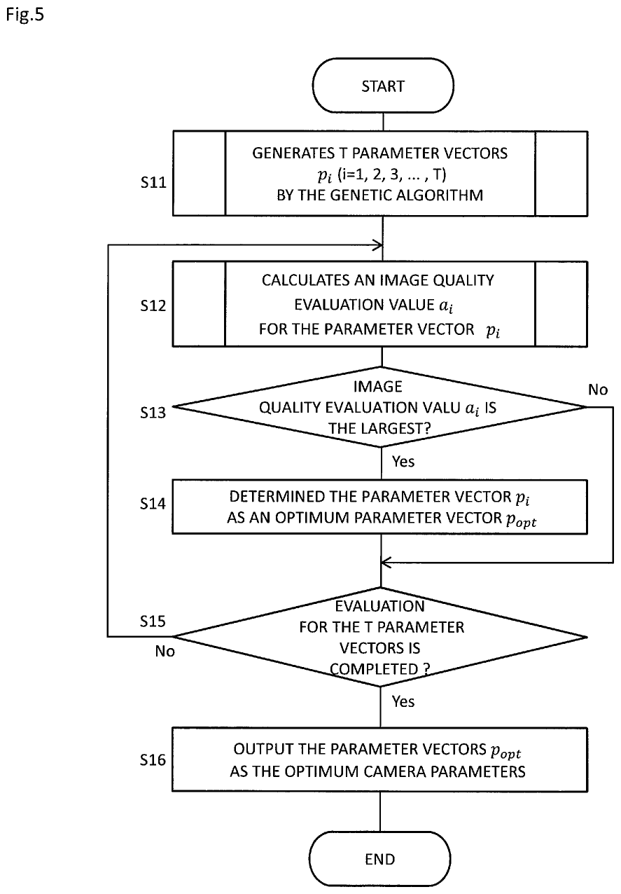

FIG. 5 is a flowchart showing an operation of determining parameter vectors by the control circuit 20 of the imaging control device 1 in the second embodiment. The control circuit 20 generates T parameter vectors pᵢ (i=1, 2, 3, . . . , T) by the genetic algorithm (S11). FIG. 5 is the same as FIG. 2 of the first embodiment except that the parameter vector pᵢ is generated by the genetic algorithm. Specifically, steps S12 to S16 of FIG. 5 are the same as steps S2 to S6 of FIG. 2.

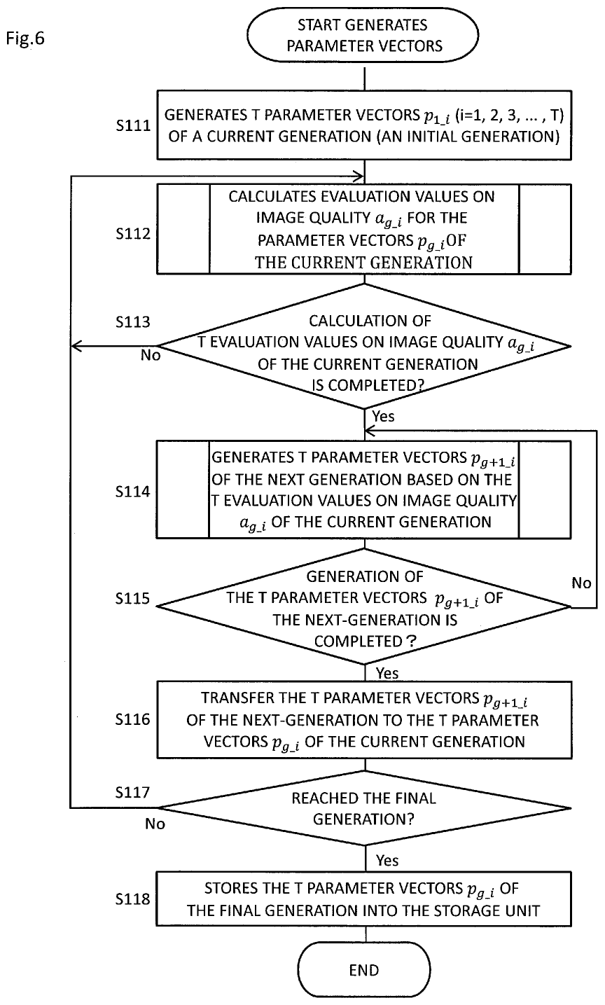

FIG. 6 shows details of the generation of the T parameter vectors pᵢ (i=1, 2, 3, . . . , T) (S11) using the genetic algorithm. The control circuit 20 generates T parameter vectors p_{1_i} (i=1, 2, 3, . . . , T) of an initial generation that is a first generation of a current generation, i.e., parameter vectors p_{1_2}, p_{1_3}, . . . P_{1_T} (S111).

The control circuit 20 calculates evaluation values on image quality a_{g_i} for the T parameter vectors p_{g_i} of the current generation (S112). Immediately after step S111, the evaluation values on image quality a_{1_i} is calculated for the T parameter vectors p_{1_i} (g=1) of the initial generation (S112). The calculation of the evaluation values on image quality at step S112 is performed by the same method as step S2 of FIG. 2. Specifically, step S112 corresponds to steps S201 to S204 shown in FIG. 3 of the first embodiment.

The control circuit 20 determines whether the calculation of the evaluation values on image quality a_{g_i} is completed for the T parameter vectors p_{g_i} of the current generation (S113). If the calculation of the evaluation values on image quality a_{g_i} for the T parameter vectors p_{g_i} of the current generation is not completed, the process returns to step S112.

When the calculation of the evaluation values on image quality a_{g_i} for the T parameter vectors p_{g_i} of the current generation is completed, the control circuit 20 generates T parameter vectors p_{g+1_i} (i=1, T) of the next generation based on the T evaluation values on image quality a_{g_i} of the current generation (S114). The control circuit 20 determines whether the generation of the T parameter vectors p_{g+1_i} of the next-generation is completed (S115). Step S114 is repeated until the number of the next-generation parameter vector p_{g+1_i} reaches T.

When the generation of the T parameter vectors p_{g+1_i} of the next-generation is completed, a value of each element of the next-generation T parameter vectors p_{g+1_i} is transferred to the T parameter vectors p_{g_i} of the current generation (S116).

The control circuit 20 determines whether the current generation has reached the final generation (S117). Steps S112 to S117 are repeated until the final generation is reached.

When the current generation reaches the final generation, the control circuit 20 stores the T parameter vectors p_{g_i} of the final generation obtained at step S116 into the storage unit 30 (S118). As a result, T parameter vectors providing the highest evaluation value on image quality in the current generation are finally obtained as the solution of the genetic algorithm.

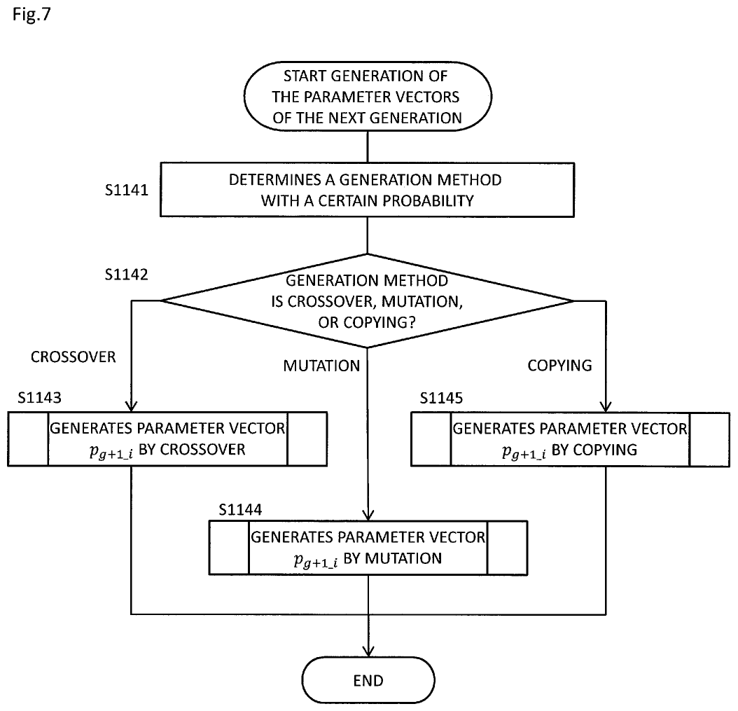

FIG. 7 shows details of generation of the T parameter vectors p_{g+1_i} of the next generation (S114). The control circuit 20 determines a generation method of the parameter vector p_{g+1_i} from crossover, mutation, and copying with a certain probability (S1141).

The control circuit 20 determines whether the determined generation method is crossover, mutation, or copying (S1142), and the control circuit 20 generates one parameter vector p_{g+1_i} by one of crossover (S1143), mutation (S1144), and copying (S1145) depending on a result of determination.

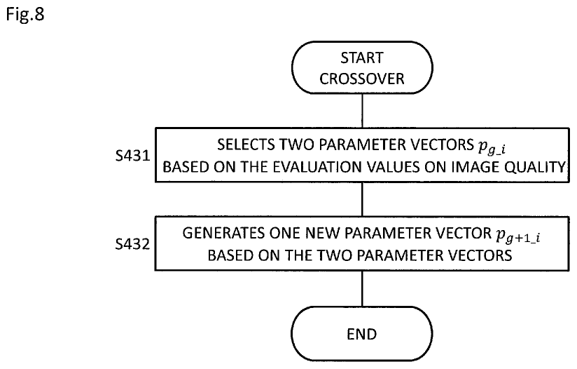

FIG. 8 is a flowchart showing details of the crossover (S1143). The control circuit 20 selects two parameter vectors p_{g_i} based on the T evaluation values on image quality a_{g_i} calculated at step S112 (S431).

The parameter vectors p_{g_i} are selected by roulette selection, for example. Specifically, based on the evaluation values on image quality a_{g_i}, the probability ri of selecting the parameter vector p_{g_i} is calculated by Eq. (3). The parameter vectors p_{g_i} are selected based on a probability rᵢ.

[Math. 3]

rᵢ=a_{g_i}/Σₖ₌₁^{T}a_{g_k} (3)

The parameter vectors p_{g_i} may be selected by ranking selection. For example, the probabilities of ranks are determined in advance, such as a probability r₁ for a first place, a probability r₂ for a second place, and a probability r₃ for a third place. The T parameter vectors p_{g_i} are ranked based on the T evaluation values on image quality a_{g_i}, and the parameter vectors p_{g_i} are selected based on the probability corresponding to the ranking.

The control circuit 20 generates one new parameter vector p_{g+1_i} based on the two parameter vectors p_{g_i} (S432). For example, the elements of the two parameter vectors p_{g_i} are independently replaced with a probability of 1/2 to generate the parameter vector p_{g+1_i}.

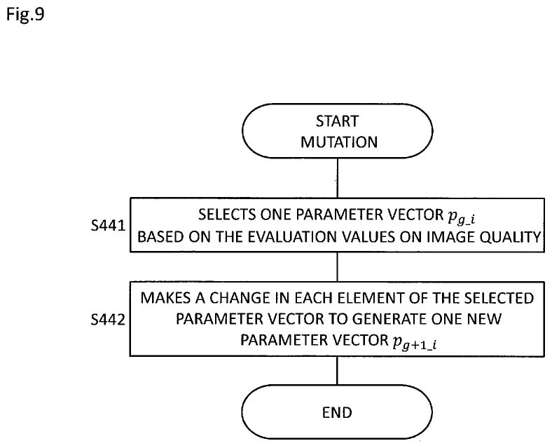

FIG. 9 is a flowchart showing details of the mutation (S1144). The control circuit 20 selects one parameter vector p_{g_i} based on the T evaluation values on image quality a_{g_i} calculated at step S112 (S441). The parameter vector p_{g_i} is selected by the roulette selection or the ranking selection described above, for example. The control circuit 20 makes a change in each element of the selected parameter vector p_{g_i} to generate one new parameter vector p_{g+1_i} (S442). For example, each element of the parameter vector p_{g_i} is randomly changed. Specifically, for example, each element of the parameter vector p_{g_i} is independently replaced with a random number or a value prepared in advance with a probability of 0.1% to generate the parameter vector p_{g+1_i}.

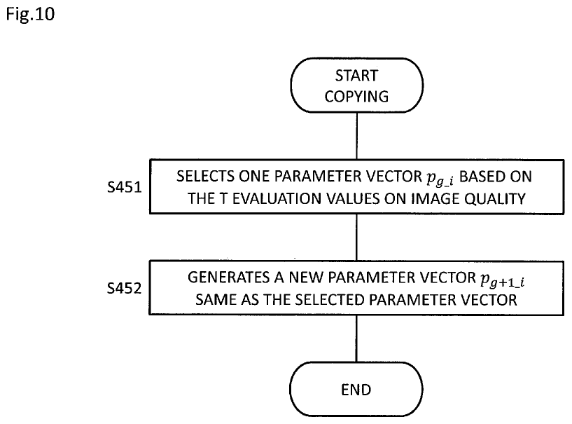

FIG. 10 is a flowchart showing details of copying (S1145). The control circuit 20 selects one parameter vector p_{g_i} based on the T evaluation values on image quality a_{g_i} calculated at step S112 (S451). The parameter vector p_{g_i} is selected by the roulette selection or the ranking selection described above, for example. The control circuit 20 generates a new parameter vector p_{g+1_i} that is the same as the selected parameter vector p_{g_i} (S452).

As a result, the T parameter vectors p₁, p₂, p₃, . . . , P_{T} generated at step S11 are parameter vectors providing high evaluation values on image quality. Therefore, by selecting one of the parameter vectors at steps S12 to S15, a parameter vector providing a higher evaluation value on image quality can be selected.

### Other Embodiments

As described above, the first and second embodiments have been described as exemplification of the techniques disclosed in the present application. However, the techniques in the present disclosure are not limited thereto and are also applicable to embodiments with modifications, replacements, additions, omissions, etc. made as appropriate. Therefore, other embodiments will hereinafter be exemplified.

In the embodiments, in the calculation of the evaluation value on image quality (S204), the L2 norm of the feature vector is used as an example of determining a parameter suitable for face recognition using deep learning. However, the method of calculating the evaluation value on image quality is not limited to the embodiments. For example, the evaluation value on image quality may be calculated by a function using a feature vector as an input value. For example, the method of calculating the evaluation value on image quality may be changed depending on a technique of face recognition. A technique of face recognition using a Gabor filter is known (see “Statistical Method for Face Detection/Face Recognition”, Takio Kurita, Neuroscience Research Institute, National Institute of Advanced Industrial Science and Technology). In this case, the evaluation value on image quality may be calculated based on a Gabor feature. The Gabor feature is a feature that can be calculated by using a Gabor filter and that is based on a specific frequency component in a specific direction. It is known that this Gabor feature is affected by noise (see, e.g., “Recognition of Cracks in Concrete Structures Using Gabor Function”, 22nd Fuzzy System Symposium, Sapporo, Sep. 6-8, 2006). It is known that the Gabor feature amount is affected by blurring (see “Research on Blurred Region Detection Using Gabor Filter”, the 22th Symposium on Sensing via Image Information, Yokohama, June 2015). Therefore, a correlation probably exists between the evaluation value on image quality based on the Gabor feature of the face image and the performance of face recognition. When the evaluation value on image quality based on the Gabor feature is calculated, at step S204, the sum of the elements corresponding to a specific frequency among the feature vectors v_{i,j}=(v_{i,j,1}, v_{i,j,2}, v_{i,j,3}, . . . , v_{i,j,D}) of the j-th (1,2 . . . N) face image is used as the evaluation value on image quality a_{i,j} of the j-th face image. The evaluation value on image quality aᵢ of the parameter vector pᵢ is calculated by Eq. (2) based on the evaluation values on image quality a_{i,j} of N face images.

In the embodiments, the one camera control device 3 is connected to the one camera 2; however, the multiple cameras 2 may be connected to the one camera control device 3. The number of the camera control devices 3 connected to the imaging control device 1 may be one or more.

In the example described in the embodiments, the imaging control device 1 such as a server determines the parameters, and the camera control device 3 such as a personal computer sets the parameters in the camera 2; however, the functions of the imaging control device 1 and the camera control device 3 may be performed by one device.

In the embodiments, the imaging control device 1 generates the T parameter vectors pᵢ (S1 and S11); however, a person may generate the T parameter vectors pᵢ.

In the embodiments, the camera control device 3 sets the camera 2 based on the parameter vectors pᵢ received from the imaging control device 1. However, a person may set some or all of the parameters of the camera 2.

In the example described in the embodiments, a group of parameters suitable for face recognition is determined; however, the determined group of parameters group may not be suitable for face recognition. The group of parameters corresponding to the installation position of the camera 2, the intended purpose of imaging data, etc. may be determined. In this case, the image extracted at step S203 is not limited to the face image. The feature vector is not limited to the vector indicative of the feature of the face image. The image to be extracted and the feature may be changed depending on an object to be automatically recognized. For example, when a group of parameters suitable for automatic recognition of an automobile, the image to be extracted is an automobile image, and a neural network having learned automobile images may be used to generate a feature vector indicative of features of an automobile.

### Overview of Embodiments

(1) The imaging control device of the present disclosure is an imaging control device determining a group of parameters related to a shooting operation of a camera, including: an input unit inputting imaging data generated by the camera; and a control circuit selecting a group of parameters to be set in the camera from candidate groups of parameters based on the imaging data. The control circuit acquires, via the input unit, the imaging data generated by the camera to which each candidate group of parameters is set, extracts a plurality of extraction object images each including an extraction object, from the imaging data for each of the candidates, calculates an evaluation value on image quality based on the plurality of extraction object images for each of the candidate groups, and selects any one group of parameters from the candidate groups of parameters based on the evaluation values on image quality.

In this way, by determining the group of parameters based on the imaged data of the camera 2, parameter values corresponding to the installation position of the camera 2 and the lighting condition of the surrounding environment can be selected. Additionally, since this eliminates the need for a person to adjust the parameter values, a work cost can be reduced.

(2) In the imaging control device of (1), the control circuit may select a group of parameters providing the largest evaluation value on image quality among the evaluation values on image quality of the respective candidate groups.

As a result, the group of parameters more suitable for the installation position of the camera 2 and the lighting condition of the surrounding environment can be selected.

(3) In the imaging control device of (1) or (2), the extraction object may be a human face, and the evaluation value on image quality may correspond to a degree of match for face recognition.

As a result, a group of parameters suitable for face recognition is selected, so that performance of face recognition is improved.

(4) In the imaging control device of (1) to (3), the control circuit may generate the candidate groups of parameters by using a genetic algorithm.

As a result, a better group of parameters can be selected from the candidate groups of parameters providing high evaluation values on image quality.

(5) In the imaging control device of (1) to (4), the control circuit may calculate the evaluation value on image quality by calculating an L2 norm of features of the plurality of extraction object images.

(6) In the imaging control device of (1) to (4), the control circuit may calculate the evaluation value on image quality by calculating Gabor features of the plurality of extraction object images.

(7) In the imaging control device of (1) to (6), the group of parameters may include at least two of aperture value, gain, white balance, shutter speed, and focal length.

(8) The imaging control method of determining a group of parameters related to a shooting operation of a camera, the method comprising the steps of: by use of an processing unit, acquiring, via an input unit, imaging data generated by the camera to which each candidate group of parameters is set; extracting a plurality of extraction object images each including an extraction object, from the imaging data for each candidate group; calculating an evaluation value on image quality based on the plurality of extraction object images for each of the candidates; and selecting the group of parameters to be set in the camera from the candidate groups of parameters based on the evaluation values on image quality.

The imaging control device and the imaging control method according to all claims of the present disclosure are implemented by cooperation etc. with hardware resources, for example, a processor, a memory, and a computer program.

The imaging control device of the present disclosure is useful for setting parameters of a surveillance camera, for example.

What is claimed is:

1. An imaging control device determining a group of parameters related to a shooting operation of a camera and suitable for automatic face recognition, comprising:
a communication circuit inputting imaging data generated by the camera; and
a control circuit selecting a group of parameters set in the camera from candidate groups of parameters based on the imaging data, wherein
the control circuit acquires, via the communication circuit, each imaging data generated by the camera to which each candidate group of parameters is set,
extracts a plurality of face images each including a human face, from the imaging data for each candidate group,
calculates an evaluation value on image quality corresponding to a degree of match of automatic face recognition based on the plurality of face images for each candidate group, and
selects any one group of parameters from the candidate groups of parameters based on evaluation values on image quality.

2. The imaging control device according to claim 1, wherein
the control circuit selects the group of parameters providing the largest evaluation value on image quality among the evaluation values on image quality of the respective candidate groups.

3. The imaging control device according to claim 1, wherein
the control circuit generates the candidate groups of parameters by using a genetic algorithm.

4. The imaging control device according to claim 1, wherein the control circuit calculates an L2 norm of respective features of the plurality of face images and calculates the evaluation value on image quality based on the L2 norm.

5. The imaging control device according to claim 1, wherein the control circuit calculates respective Gabor features of the plurality of face images and calculates the evaluation value on image quality based on the Gabor features.

6. The imaging control device according to claim 1, wherein the group of parameters includes at least two of aperture value, gain, white balance, shutter speed, and focal length.

7. An imaging control method of determining a group of parameters related to a shooting operation of a camera and suitable for automatic face recognition, the method comprising the steps of:
by use of an processing unit,
acquiring, via a communication circuit, imaging data generated by the camera to which each candidate group of parameters is set;
extracting a plurality of face images each including a human face, from the imaging data for each candidate group;
calculating an evaluation value on image quality corresponding to a degree of match of automatic face recognition based on the plurality of face images for each candidate group; and
selecting the group of parameters to be set in the camera from the candidate groups of parameters based on the evaluation values on image quality.

8. A non-transitory computer-readable recording medium storing a computer program causing a control circuit included in a imaging control device to execute:
extracting a plurality of face images each including a human face from the imaging data for each of the candidates;
calculating an image quality evaluation value corresponding to a degree of suitability for automatic face recognition based on the plurality of face images for each of the candidates; and
selecting the parameter group set in the camera from the plurality of candidates for the parameter group based on the image quality evaluation value.
